(19) United States
(12) Patent Application Publication
(10) Pub. No.: US 2002/0038953 A1
(43) Pub. Date: Apr. 4, 2002

(54) Fluid couplings

(76) Inventors: Robert Kenneth Mcnab, Mt Martha (AU); Desmond John Berry, Mt Eliza (AU)

Correspondence Address: LARSON & TAYLOR, PLC, 1199 NORTH FAIRFAX STREET, SUITE 900, ALEXANDRIA, VA, 22314, US

(21) Appl. No.: 09/825,343

(22) Filed: Apr. 4, 2001

(30) Foreign Application Priority Data
Oct. 2, 2000 (AU) 62430 / 00

(51) Int. Cl. F16L 33/00

(52) U.S. Cl. 285/255

(57) ABSTRACT

A fluid coupling 10 comprising a length of flexible tubing 11 having a free end 12, a connector 13 having at least one end with at least one radially projecting rib, the end being adapted to be a force fit within the free end of the tubing so that the rib causes a radially outward expansion of the tubing, and a locking ring 30 having an inextensive band 31 coupled to resilient gripping means, the locking ring 30 being adapted to be a sliding fit on the tubing but an interference fit on the expanded portion of the tubing to cause the gripping means to engage and grip against the tubing to prevent axial separation of the tubing from the connector 13.

### FIELD OF THE INVENTION

This invention relates to fluid couplings especially those for use with flexible pipework.

### BACKGROUND OF THE INVENTION

There are many types of fluid couplings that essentially comprise flexible tubing, pipework or hose that is press fitted onto a semi-rigid connector usually moulded in plastics. The end fitting of the connector usually has tapered annular retaining rings that the tubing has to be forced over to hold the tubing onto the connector. These connections are used in such simple environments as sprinkler systems in gardens but are also used in more sophisticated environments such as fuel lines or air lines for air driven machinery and air lines for use in spas and pools.

A problem with this type of coupling concerns the possibility of the internal pressure forcing the flexible tubing off the connector. The internal pressure causes the flexible tubing to expand releasing the interference fit between the locating rings and the tubing and thus pushing the tubing back off the connector. There are a number of ways of reducing the likelihood of this failure including the use of adhesives between the connector and the tubing or, more usually, the provision of an adjustable locking band that is fitted around the exterior of the tubing over the connector. The locking band can be adjusted to clamp the tubing against the connector. Adjustable locking hands do however suffer from problems that they are often incorrectly fitted or in the more sophisticated type that have a threaded adjustment they do not provide uniform pressure around the whole periphery of the tubing. In tight and confined spaces the locking bands can also be difficult to fit or remove for disassembly.

It is these problems that have brought about the present invention.

### SUMMARY OF THE INVENTION

According to the present invention there is provided a fluid coupling comprising a length of flexible tubing having a free end, a connector having at least one end with at least one radially projecting rib, the end being adapted to be a force fit within the free end of the tubing so that the rib causes a radially outward expansion of the tubing, and a locking ring having an inextensive band coupled to resilient gripping means, the locking ring being adapted to be a sliding fit on the tubing but an interference fit on the expanded portion of the tubing to cause the gripping means to engage and grip against the tubing to prevent axial separation of the tubing from the connector.

### DESCRIPTION OF THE DRAWINGS

Embodiments of the present invention will now be described by way of example only with reference to the accompanying drawings in which:

FIG. 1 is a schematic side elevational view of a fluid coupling in accordance with a first embodiment of the invention;

FIG. 2 is a cross sectional view of the coupling;

FIG. 3 is a perspective view of part of a locking ring that forms part of the coupling, and

FIG. 4 is a cross sectional view of a modified form of the fluid coupling.

### DESCRIPTION OF THE PREFERRED EMBODIMENTS

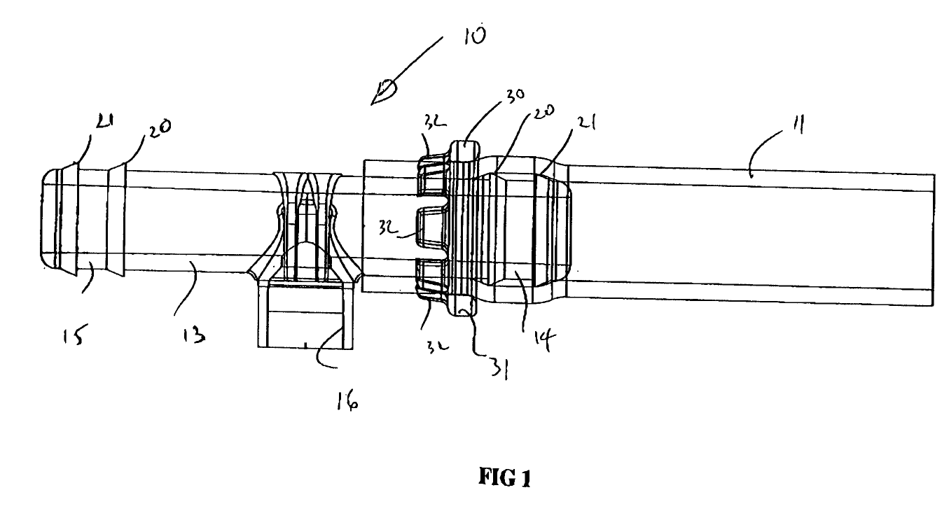

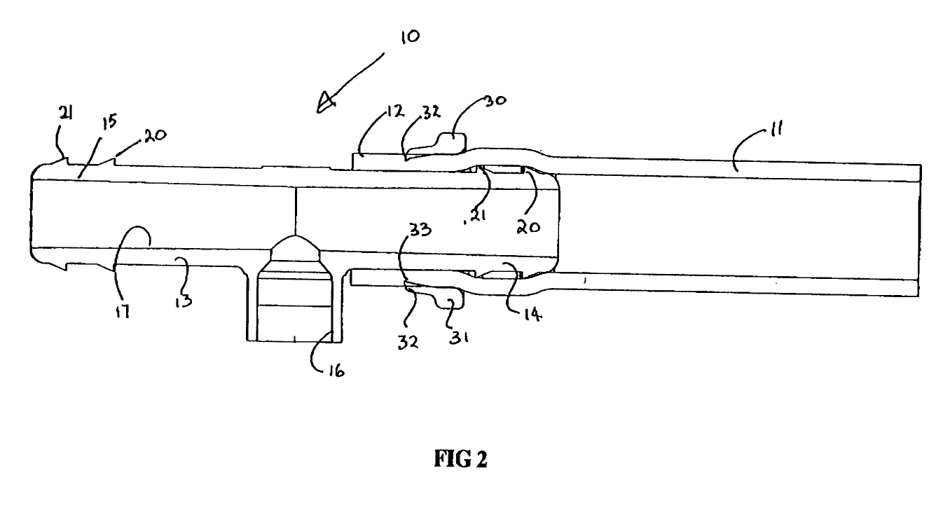

As shown in FIGS. 1 to 3 of the accompanying drawings a fluid coupling 10 comprises a length of plastics tubing 11 having a free end 12 that is arranged to be a forced fit on a semi rigid plastics connector 13 which is in the form of, for example, a T-piece having an inlet end 14, outlet end 15 and T-junction 16. The plastics connector 13 has an internal throughway 17 and the connector of the inlet and outlet ends 14 or 15 are provided with a pair of spaced apart annular ribs 20 and 21. The annular ribs 20, 21 have an outer profile that tapers outwardly towards the center of the connector to provide a leading taper that enables the free end 12 of the tubing 11 to be forced over the ribs 20, 21 so that the ribs force the wall of the tubing to flex outwardly and bite into the interior surface of the tubing to reduce the likelihood of the tubing being forced off the connector by the internal fluid pressure.

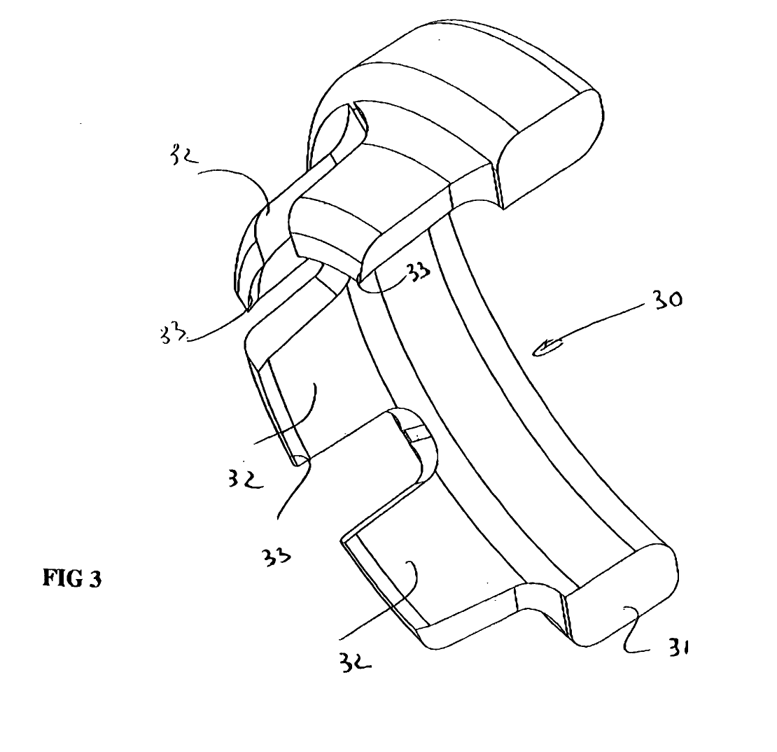

A locking ring 30 is positioned on the exterior of the assembly to hold the adjacent portion of the tubing against the connector. The locking ring 30 is shown in FIG. 3 and essentially comprises a plastics moulding in the form of an inextensible annular band 31 from which a plurality of equally spaced teeth 32 project axially. Each tooth terminates in a downwardly turned edge defining a sharp arcuate rim 33. The teeth 32 have a degree of inherent flexibility that allows them to flex radially outwardly.

To assemble the coupling the locking ring 30 is first slid onto the connector 13. The internal diameter of the locking band 31 is greater than the maximum diameter of the connector 13 so it is easy to slide the locking ring 30 onto the connector which is then located towards the centre of the connector. The free end 12 of the tubing 11 is then forced over the end 14 of the connector to assume the position as shown in FIG. 1. The locking ring 30 is then pushed back over the tubing. The internal diameter of the band 31 of the locking ring 30 is slightly greater than the tube but the internal diameter defined by the teeth 32 is of smaller diameter so that as the ring 30 is pulled back over the tube it stops where the band 31 contacts the portion of the tube that has been expanded outwardly by the ribs 20, 21. The interference between the expanded exterior of the tubing 11 and the internal surface of the band 31 causes a wedging action holding the locking ring 30 in position on the connector. In this position as shown in FIG. 1 the teeth 32 push into the outer surface of the tubing.

When the coupling becomes subject to internal pressure that might cause the tubing to be forced off the connector 13, the teeth 32 embedded in the tubing cause the locking ring 30 to be dragged back with the tubing squeezing the tubing between band 31 and rib 21. The locking ring is firmly held onto the tubing and the interaction of the teeth 32 with ribs 20, 21 of the connector effectively prevent separation of the components and considerably improve the capacity of the fluid coupling to resist high internal pressures.

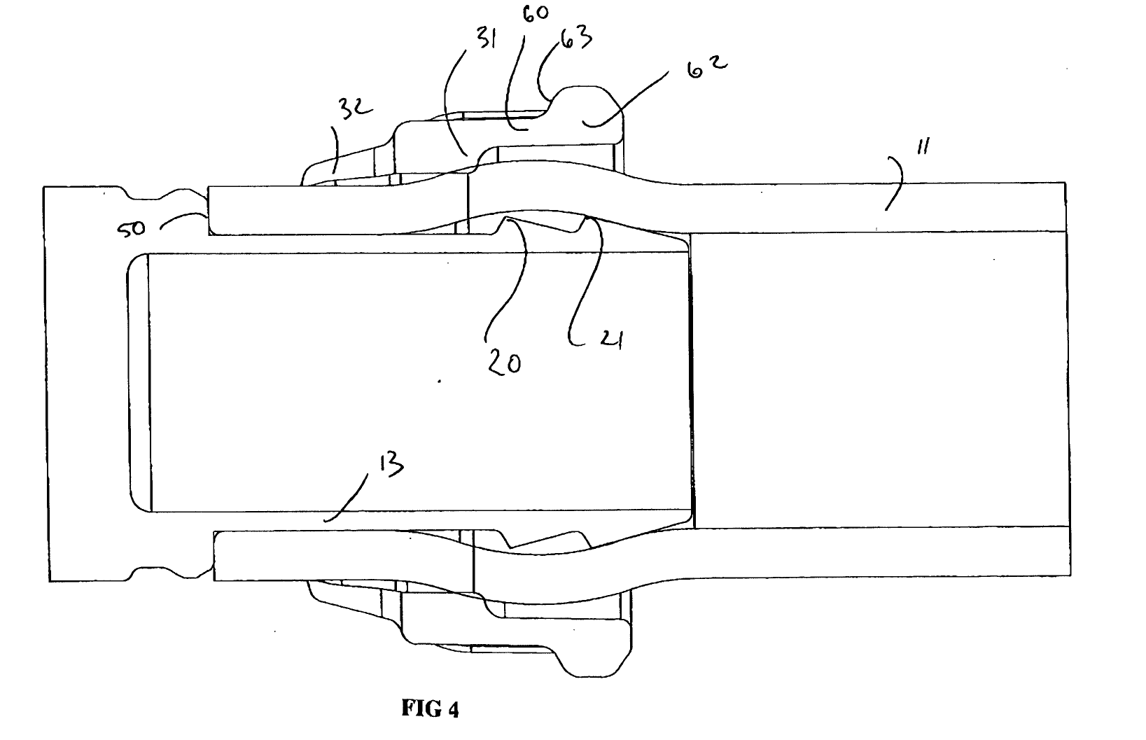

In the embodiment shown in FIG. 4, a modified fluid coupling is illustrated. The same reference numerals are used for like components. In this embodiment the flexible tubing 11 fits onto the connector 13 in the same manner as the first embodiment, that is with the ribs 20 and 21 forcing the tubing 11 to expand radially outwardly. In this embodiment the free end of the tubing 11 abuts a shoulder 50 formed on the exterior surface of one end of the coupling 13. The locking ring 60 is very similar to the locking ring 30 of the first embodiment except that the inextensible band 31 has a forward projecting annular flange 62, the exterior surface 63 of which provides a gripping portion to enable the locking ring to be firmly located on the tubing. The locking ring 60 has similar trailing teeth 32 that embed into the exterior surface of the tubing. The interior diameter of the forwardly projecting flange 62 is arranged to be greater than the external diameter of the tubing and, as shown in FIG. 4, the internal diameter of the inextensible band 31 is slightly less than the external diameter of the tubing when expanded radially outwardly to cause an interference fit. Otherwise the coupling of this embodiment operates in the same manner as the coupling of the first embodiment.

In the embodiment described above the fluid coupling is used in a pool/spa pump in the air line of that assembly where a flexible plastics tubing is used to supply air to a water jet assembly. The semi-rigid plastics connector 13 couples the air line to the jet assembly. In this environment there is a need for a simple and reliable coupling that will not separate in a high pressure environment. It is however understood that the coupling can be used in many other situations such as garden watering, irrigation installations.

Having now described the invention, what we claim is:

1. A fluid coupling comprising a length of flexible tubing having a free end, a connector having at least one end with at least one radially projecting rib, the end being adapted to be a force fit within the free end of the tubing so that the rib causes a radially outward expansion of the tubing, and a locking ring having an inextensible band coupled to resilient gripping means, the locking ring being adapted to be a sliding fit on the tubing but an interference fit on the expanded portion of the tubing to cause the gripping means to engage and grip against the tubing to prevent axial separation of the tubing from the connector.

2. The fluid coupling according to claim 1 wherein the connector has a pair of spaced apart ribs, each rib having an inclined leading face to facilitate entry of the connector into the end of the tubing.

3. The fluid coupling according to claim 1 wherein the gripping means comprises a plurality of spaced fingers extending behind the inextensible band.

4. The fluid coupling according to claim 3 wherein the fingers having radially inward projecting edges that resiliently engage and grip into the outer surface of the tubing.

5. The fluid coupling according to claim 4 wherein the diameter defined by the projecting edges of the fingers is less than the inner diameter of the inextendible band.

6. The fluid coupling according to claim 1 wherein the locking ring is moulded in plastics.

7. The fluid coupling according to claim 1 wherein the band has a forwardly projecting annular flange, the exterior of which serves as a gripping portion.

8. The fluid coupling according to claim 7 wherein the inner diameter of the flange is greater than the outer diameter of the tubing.

9. A locking ring for use with a fluid coupling of the kind in which a length of flexible tubing having a free end is attached to a connector having at least one radially projecting rib so that the rib causes radial outward expansion of the tubing, the locking ring comprising an inextensible band coupled to resilient gripping means, whereby the locking ring is adapted to be in use, a sliding fit on the tubing but an interference fit on the expanded portion of the tubing to cause the gripping means to engage and grip against the tubing to prevent axial separation of the tubing from the connector.
